(19) United States
(12) Patent Application Publication
(10) Pub. No.: US 2008/0049284 A1
(43) Pub. Date: Feb. 28, 2008

(54) LASER DISPLAY APPARATUS

(75) Inventors: Ki-soo PARK, Yongin-si (KR); Alexei Borodouline, Suwon-si (KR); Joon-seok Moon, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/837,832

(22) Filed: Aug. 13, 2007

(30) Foreign Application Priority Data
Aug. 28, 2006 (KR) 10-2006-0081839

(51) Int. Cl. G02B 26/08; G02B 27/28

(52) U.S. Cl. 359/196; 359/483

(57) ABSTRACT

A laser display apparatus which reduces speckles, includes: a laser illuminating system emitting a laser beam; and a speckle reducing unit including a birefringent device that separates the laser beam emitted from the laser illuminating system into a plurality of partial beams, and a plurality of spots formed by the partial beams, separated by the speckle reducing unit, on a screen overlap with each other with a slight displacement so that the speckle pattern is reduced.

### CROSS-REFERENCE TO RELATED PATENT APPLICATIONS

This application claims the benefit of Korean Patent Application No. 10-2006-0081839, filed on Aug. 28, 2006, in the Korean Intellectual Property Office, the disclosure of which is incorporated herein in its entirety by reference.

### BACKGROUND OF THE INVENTION

1. Field of the Invention

The present invention relates to a laser display apparatus, and more particularly, to a laser display apparatus reducing a speckle pattern caused by coherence of a laser light source.

2. Description of the Related Art

Semiconductor lasers have high photoelectron conversion efficiency and high directionality, and thus, are suitable as a light source in a display apparatus. However, due to speckle noises generated by high coherence of the laser, it is difficult to use a semiconductor laser as the light source in a display apparatus. The speckle noise occurs when coherent beams having arranged phases are scattered on a screen, that is, an arbitrary phase surface, and wave fronts that are scattered on adjacent portions on the screen interfere with each other on a retina, that is, an observing surface. The speckle noise is manifested as uneven light intensity distribution on the observing surface, and consequently, causes an image quality degradation of the display apparatus.

An example of a conventional laser display apparatus that removes the speckle noises by shaking images formed on the screen using an active device such as an acousto-optic modulator (AOM) is shown in U.S. Pat. No. 6,625,381. However, the above method using the active device has some problems. For instance, light loss is generated due to the active device and a spot size of the beam focused on the screen due to the shaking of the image on the screen increases, and thus, resolution of the display apparatus may be lowered.

Another example of the laser display apparatus for reducing the speckle pattern is disclosed in U.S. Pat. No. 6,897,992. The laser display apparatus divides a laser beam emitted from the laser into two paths according to polarization directions thereof, and applies an optical path difference between the two paths in order to reduce the speckle pattern occurring on the screen. However, according to this method, the optical path difference must be large enough to remove the coherence between the separated two laser beams, and thus, the display apparatus must have a large size.

### SUMMARY OF THE INVENTION

Illustrative, non-limiting exemplary embodiments of the present invention overcome the above disadvantages, and other disadvantages not described above.

An apparatus consistent with the present invention reduces speckle patterns using a simple optical structure that does not reduce an optical efficiency.

According to an aspect of the present invention, there is provided a laser display apparatus including: a laser illuminating system emitting a laser beam; and a speckle reducing unit including a birefringent device that separates the laser beam emitted from the laser illuminating system into a plurality of partial beams; wherein a plurality of spots formed by the partial beams separated by the speckle reducing unit on a screen overlap with each other with a slight displacement therebetween so that a speckle pattern is reduced.

The speckle reducing unit may further include: a polarization converter disposed between the laser illuminating system and the birefringent device for changing the incident laser beam into a laser beam including a first polarization component and a second polarization component which are orthogonal to each other.

The birefringent device may include at least two birefringent media, and an incident surface and an exit surface of the birefringent device are parallel to each other.

The birefringent media may be bonded to each other so that optical axes cross each other.

A flat plate type transparent member may be disposed between the birefringent media.

The laser display apparatus may further include: a light scanning unit deflecting the laser beam and scanning the laser beam onto the screen, wherein the speckle reducing unit is disposed between the laser illuminating system and the optical scanning unit.

The laser display apparatus may further include: a beam shaping element shaping the beam emitted from the laser illuminating system into a beam having a linear cross section; a line panel modulating the laser beam output from the beam shaping element according to an image signal; and a one-dimensional optical scanner scanning the laser beam in a direction perpendicular to a length direction of the line panel in synchronization with the image signal.

The laser display apparatus may further include: a flat panel modulating the laser beam emitted from the laser illuminating system according to an image signal to form an image; and a projection optics unit expanding and projecting the image formed by the flat panel onto the screen.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a laser display apparatus according to an exemplary embodiment of the present invention;

FIG. 2 is a schematic view of a laser illuminating system in the display apparatus of FIG. 1;

FIGS. 3A and 3B are views of an optical structure of a birefringent device of FIG. 1 and an optical proceeding path of the birefringent device;

FIG. 4 is a view of overlapped spots of laser beams that are separated by the birefringent device of FIG. 3A;

FIGS. 5A and 5B are views illustrating an optical structure of a modified example of the birefringent device of FIG. 1 and an optical proceeding path of laser light through the birefringent device;

FIG. 6 is a view of overlapped spots of laser beams that are separated by the birefringent device of FIG. 5A;

FIGS. 7 through 10 are views illustrating optical structures of other modified examples of the birefringent device of FIG. 1 and optical proceeding paths of laser light through the devices;

FIG. 11 is a view of an optical structure of a laser display apparatus according to another exemplary embodiment of the present invention and an optical proceeding path through the apparatus; and

FIG. 12 is a view of an optical structure of a laser display apparatus according to another exemplary embodiment of the present invention and an optical proceeding path through the apparatus.

### DETAILED DESCRIPTION OF THE INVENTION

The present invention will now be described more fully with reference to the accompanying drawings, in which exemplary embodiments of the invention are shown.

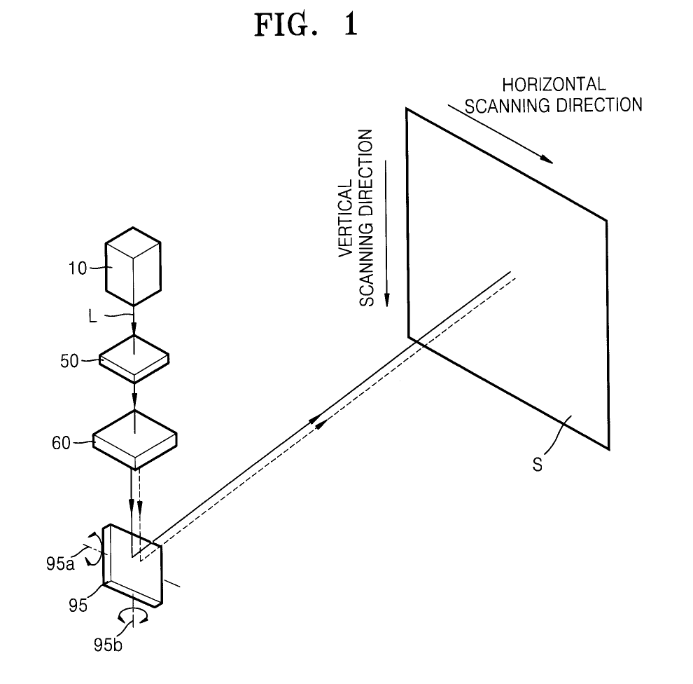

FIG. 1 is a schematic view of a laser display apparatus according to an embodiment of the present invention.

Referring to FIG. 1, the laser display apparatus of the current embodiment includes a laser illuminating system 10 emitting laser beam L, a speckle reducing unit separating the laser beam L emitted from the laser illuminating system 10 into two partial beams (not written on FIG. 1) L₁ and L₂, a dual-axis driving micro scanner 95 scanning the partial beams L₁ and L₂, and a screen S on which an image is formed. The speckle reducing unit includes a quarter wave plate 50 and a birefringent device 60. Two spots formed on the screen S by the partial beams L₁ and L₂ separated by the speckle reducing unit overlap with each other, and form a pixel.

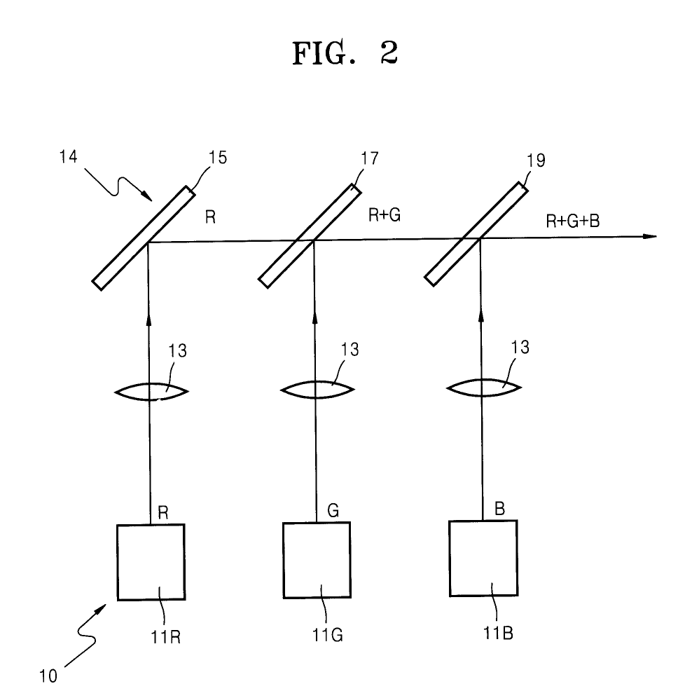

The laser illuminating system 10, for example, includes a red laser light source 11R, a green laser light source 11G, and a blue laser light source 11B respectively emitting red, green, and blue laser beams R, G, and B for displaying color images, and a colored light coupler 14 for coupling paths of the laser beams having different wavelengths from each other emitted from the laser light sources 11R, 11G, and 11B, as shown in FIG. 2. A collimating lens 13 can be disposed at an output end of each of the laser light sources 11R, 11G, and 11B.

Semiconductor lasers emitting red, green, and blue wavelength laser beams R, G, and B can be used as the laser light sources 11R, 11G, and 11B. Other laser light sources except for the semiconductor lasers, for example, solid state lasers, can be used as the laser light sources 11R, 11G, and 11B.

In a case where semiconductor lasers are used as the red, green, and blue laser light sources (11R, 11G, and 11B of FIG. 2), the laser beam of each wavelength can be modulated and output according to an image signal. In a case where other laser light sources besides the semiconductor lasers are used as the red, green, and blue laser light sources 11R, 11G, and 11B, an additional light modulator (not shown) can be disposed on each light path of the red, green, and blue laser beams R, G, and B emitted from the laser light sources 11R, 11G, and 11B to modulate the laser beam. Also, in the case where the semiconductor lasers are used as the red, green, and blue laser light sources 11R, 11G, and 11B, an additional light modulator can be used to modulate the laser beams instead of directly modulating the output of the semiconductor lasers.

The colored light coupler 14 can include, for example, first through third dichroic mirrors 15, 17, and 19. The first dichroic mirror 15 is disposed at an output end of the red laser light source 11R, the second dichroic mirror 17 is disposed at an output end of the green laser light source 11G, and the third dichroic mirror 19 is disposed at an output end of the blue laser light source 11B. The first dichroic mirror 15 reflects the red laser beam R. The second dichroic mirror 17 reflects the green laser beam G and transmits the red laser beam R. The third dichroic mirror 19 reflects the blue laser beam B, and transmits the red and green laser beams R and G. When the second dichroic mirror 17 is disposed on a light path of the red laser beam R and the third dichroic mirror 19 is disposed on light paths of the red and green laser beams R and G, the light paths of the red, green, and blue laser beams R, G, and B coincide with each other. Therefore, the light paths of the red, green, and blue laser beams R, G, and B emitted from the red, green, and blue laser light sources 11R, 11G, and 11B are combined with each other by the colored light coupler 14.

The laser illuminating system 10 having the above structure emits a plurality of laser beams, for example, red, green, and blue laser beams R, G, and B through a single light path. The laser illuminating system 10 does not limit the technical scope of the present invention, and various structures known in the art can be used as the laser illuminating system.

Referring to FIG. 1, the speckle reducing unit includes a birefringent device 60 separating the laser beam L emitted from the laser illuminating unit 10 into a plurality of partial beams L₁ and L₂.

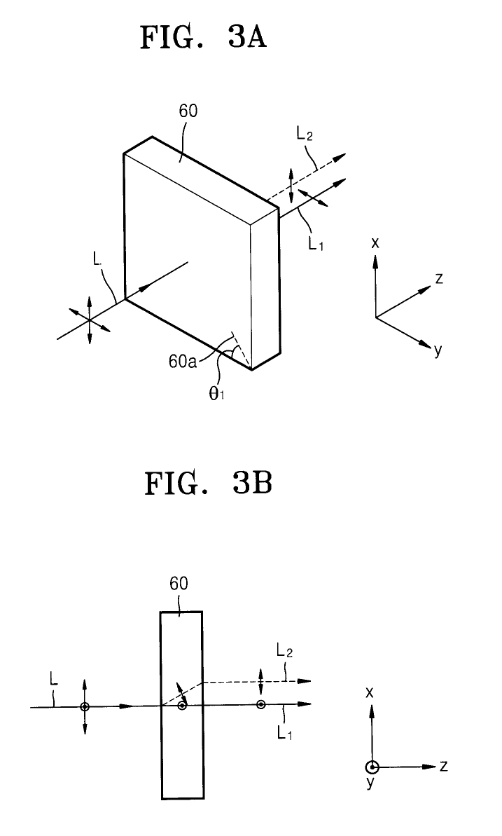

FIGS. 3A and 3B show an example of the birefringent device 60.

Referring to FIGS. 3A and 3B, the birefringent device 60 according to the current embodiment is formed of a flat plate type birefringent medium. The birefringent medium may be uniaxial or biaxial, however, the birefringent device 60 of the present invention is not limited to a certain type of birefringent medium. In the current embodiment, the birefringent device formed of a uniaxial birefringent medium will be described.

In general, rays passing through the birefringent medium have different velocities from each other according to polarization directions thereof. That is, according to a crystallization structure of the birefringent medium, an ordinary ray having a polarization direction that is perpendicular to an optical axis that is an axis of rotation symmetry and an extraordinary ray having a polarization direction that is not perpendicular to the optical axis have different velocities from each other. For example, the uniaxial birefringent medium such as a calcite has one optical axis, and thus, the ray incident on the birefringent medium and having a polarization direction at an angle to the optical axis is separated into two rays having two different velocities.

The birefringent device 60 according to the current embodiment has an optical axis 60a that is inclined with respect to polarization directions of the laser beam L in order to separate these polarization directions of the incident laser beam L. The birefringent device 60 may be positioned such that the optical axis 60a may be disposed perpendicularly to the proceeding direction of the incident laser beam L as shown in FIG. 3A.

In addition, the optical axis 60a of the birefringent device 60 is inclined at an angle of θ ₁ with respect to a bottom surface of the device 60. For example, if the incident laser beam L is linearly polarized in a direction parallel to the bottom surface, the inclination angle θ ₁ of the optical axis 60a may range from 40° to 50° so that the laser beam L can be separated evenly. If the laser beam L incident into the birefringent device 60 is circularly polarized, there is no particular limitation in the angle θ ₁.

Since the birefringent device 60 of the current embodiment is a flat plate type birefringent medium, the incident surface and the exit surface of the laser beam L are parallel to each other. Accordingly, the plurality of partial beams L₁ and L₂ separated by the birefringent device 60 are parallel to each other. Meanwhile, the birefringent device 60 is disposed so that the incident surface and the exit surface are perpendicular to the incident direction of the laser beam L.

For the sake of convenience, the incident direction of the laser beam L is assumed as a z direction, the direction perpendicular to the bottom surface of the birefringent device 60 is a y direction, and the direction perpendicular to a side surface of the birefringent device 60 is an x direction. According to the current embodiment, the optical axis 60a is disposed on the xy plane, however, it is not limited thereto. For example, the optical axis 60a may be disposed on the zx plane. However, the polarization directions of the separated partial beams L₁ and L₂ vary according to the direction of the optical axis 60a.

If the optical axis 60a is parallel to the x axis, that is, if the angle θ ₁ is 90°, the laser beam L having the polarization direction perpendicular to the optical axis 60a, that is, perpendicular to the zx plane, is the ordinary ray, and thus, is refracted in the birefringent device 60 according to Snell's law with respect to the reflective index nₒ for the ordinary ray. When the laser beam L is incident perpendicular to the birefringent device 60 like in the current exemplary embodiment, the ordinary ray is transmitted without being refracted. A first partial beam L₁ denoted as a solid line in FIGS. 3A and 3B is the ordinary ray. Meanwhile, the laser beam L having the polarization direction parallel to the optical axis 60a, that is, the polarization direction that is in parallel to the zx plane, is the extraordinary ray, and is refracted according to Snell's law with respect to the reflective index nₑ for the extraordinary ray in the birefringent device 60. Therefore, the laser beam L is incident perpendicularly to the birefringent device 60, the extraordinary ray is refracted separately from the ordinary ray. A second partial beam L₂ denoted by dotted line in FIGS. 3A and 3B is the extraordinary ray.

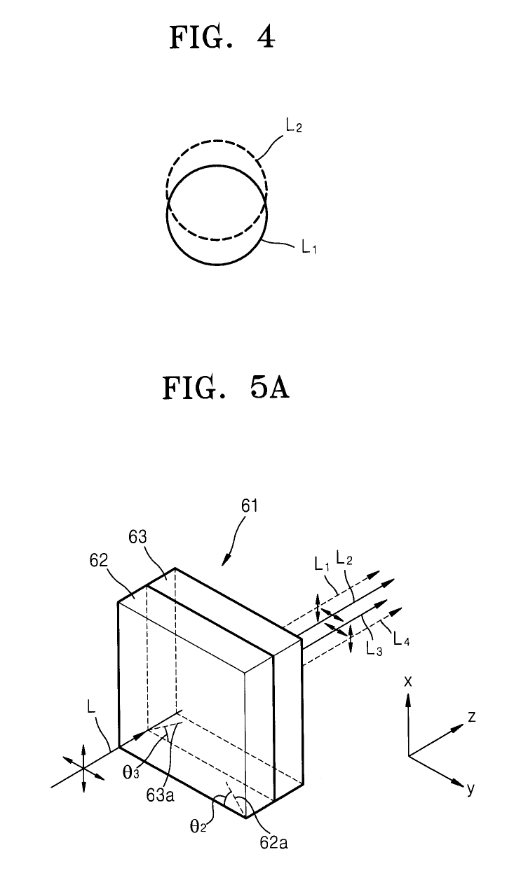

Since each of the first and second partial beams L₁ and L₂ has a predetermined beam width, the first and second partial beams L₁ and L₂ are not completely separated from each other and overlap slightly with each other. Here, the overlapping of the partial beams L₁ and L₂ means that spots formed by projecting the first and second partial beams L₁ and L₂ onto the screen S slightly overlap with each other within a range of forming one pixel as shown in FIG. 4.

Referring to FIG. 1, the speckle reducing unit further includes a quarter wave plate 50 that is disposed between the laser illuminating system 10 and the birefringent device 60. The laser beam emitted from the semiconductor laser is generally linearly polarized light, and thus, the quarter wave plate 50 can change the laser beam L emitted from the laser illuminating system 10 into circular-polarized light or elliptically polarized light. A phase retarder such as the quarter wave plate 50 is an example of a polarization converter changing the polarization of light in which a first polarization and a second polarization that are orthogonal to each other are mixed.

However, the polarization converter such as the quarter wave plate 50 is not essentially required in the present invention. For example, in a case where the laser device emits the laser beam having no polarization orientation, the polarization converter is not necessary. Otherwise, even if the laser device emits the laser beam that is linearly polarized in a predetermined direction, when the birefringent device 60 is disposed so that the optical axis (60a of FIG. 3A) is inclined at about 45° angle with respect to the polarization direction, the laser beam L can be separated into the first and second partial beams L₁ and L₂ without using the polarization converter.

The partial beams L₁ and L₂ separated by the speckle reducing unit are scanned by a dual-axis driving micro scanner 95.

The dual-axis driving micro scanner 95 deflects the laser beam L using a micro-rotation of the mirror, and scans the laser beam L emitted from the laser illuminating system 10 onto the screen S in a horizontal direction and a vertical direction of the screen S. The dual-axis driving micro scanner 95 rotates (about axes 95a and 95b) a suspending mirror that can operate as a see-saw using an electrostatic effect caused by a comb-type electrode structure, and an example of the dual-axis driving micro mirror is disclosed in Korean Registered Patent No. 0486716. Since the dual-axis driving micro scanner 95 is well known in the art, detailed descriptions of the scanner are omitted.

The dual-axis driving micro scanner 95 is an example of an optical scanning unit scanning the laser beam L emitted from the laser illuminating system 10, and in particular, is a two-dimensional scanner scanning the laser beam L in the horizontal direction and the vertical direction of the screen S. The two-dimensional scanner can be formed by combining two one-axis driving micro scanners or by combining two galvano mirrors.

Hereinafter, operations of the laser display apparatus according to the current embodiment will be described as follows.

The laser illuminating system 10 emits the laser beam towards the speckle reducing unit.

Referring to FIG. 2, the red, green, and blue laser light sources 11R, 11G, and 11B modulate the laser beam outputs according to the image signals, and output the laser beams R, G, and B that are linearly polarized. The red laser beam R emitted from the red laser light source 11R is reflected by the first dichroic mirror 15, and is transmitted through the second and third dichroic mirrors 17 and 19. The green laser beam G emitted from the green laser light source 11G is reflected by the second dichroic mirror 17, and is transmitted through the third dichroic mirror 19. In addition, the blue laser beam B emitted from the blue laser light source 11B is reflected by the third dichroic mirror 19. Accordingly, the red, green, and blue laser beams R, G, and B emitted from the red, green, and blue laser light sources 11R, 11G, and 11B proceed along a single combined light path.

Referring to FIG. 1, the polarization of the laser beam L, in which the red, green, and blue laser beams R, G, and B are combined, is changed into circular polarization by the quarter wave plate 50.

The circularly polarized laser beam L is incident perpendicular to the birefringent device 60. The optical axis (60a of FIG. 3A) of the birefringent device 60 is inclined with respect to polarization directions of the laser beam L, and thus, the circularly polarized laser beam L includes the first polarization component that is perpendicular to the optical axis 60a and the second polarization component that is perpendicular to the first polarization component. Here, the laser beam L of the polarization direction that is perpendicular to the optical axis 60a is transmitted without being refracted to be the first partial beam L₁, and the laser beam L of the polarization component that is not perpendicular to the optical axis 60a is refracted to be the second partial beam L₂. Since the incident surface and the exit surface of the laser beam L in the birefringent device 60 are parallel to each other, the plurality of partial beams L₁ and L₂ are parallel to each other.

The partial beams L₁ and L₂ that are separated by the speckle reducing unit are deflected onto the screen S by the dual-axis driving micro scanner 95 in a state where the partial beams L₁ and L₂ overlap with each other. The dual-axis driving micro scanner 95 is synchronized with the laser illuminating system 10 that emit the red, green, and blue laser beams R, G, and B that are modulated according to the image signals, and rotates the micro mirror so as to scan the partial beams L₁ and L₂ onto the screen S in the vertical scanning direction and the horizontal scanning direction. The partial beams L₁ and L₂ form the spots on the screen S to form pixels, and a two-dimensional image is formed by the scanning in the vertical and horizontal directions.

Referring to FIG. 4, the speckle reducing unit makes the spots formed on the screen S by the separated partial beams L₁ and L₂ slightly overlap with each other to form one pixel. The speckle is generated when disturbed wave fronts that are scattered in adjacent regions on the screen S interfere with each other on a retina of an observer. Two speckles generated from the two spots formed on the screen S that overlap with each other with a slight displacement have different patterns from each other. Therefore, the speckle observed when the observer views the image on the screen S is formed by overlapping the speckle patterns of the first and second partial beams L₁ and L₂, and thus, a contrast of the speckles can be equalized. In general, when the N number of beams having the same light intensity overlap with each other, the speckle contrast is reduced by 1/\sqrt{N}. In the current embodiment, since two spots overlap with each other to form one pixel, the speckle contrast is reduced by 1/\sqrt{2} on average. Moreover, since the first and second partial beams L₁ and L₂ are perpendicular to each other, the first and second partial beams L₁ and L₂ do not interfere with each other, and thus, an equalization of the speckle contrast can be performed sufficiently.

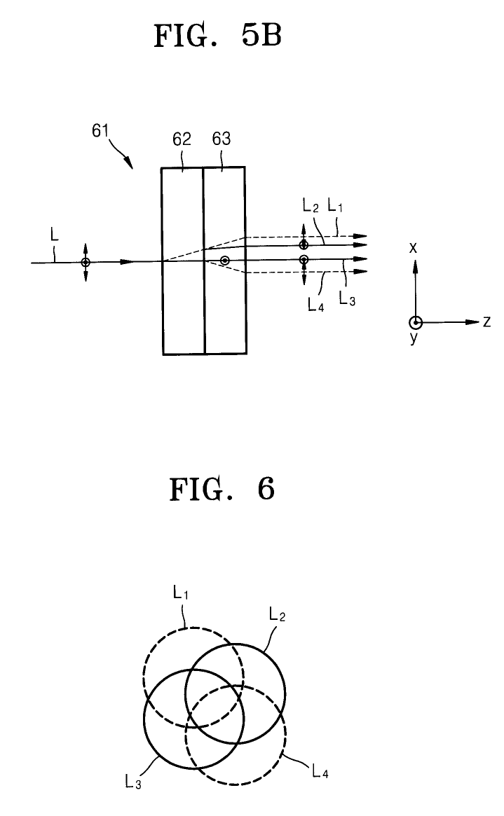

A modified example of the birefringent device according to the current embodiment will be described with reference to FIGS. 5A and 5B.

Referring to FIGS. 5A and 5B, a birefringent device 61 includes a first birefringent medium 62 and a second birefringent medium 63. The first and second birefringent media 62 and 63 are each actually the same as the birefringent device 60 described with reference to FIGS. 3A and 3B, and thus, detailed description of each of the birefringent media 62 and 63 will be omitted. In addition, other elements except for the birefringent device 60 in the laser display device in FIGS. 1 and 2 are the same, and thus, the birefringent device 61 will be described as follows.

The first and second birefringent media 62 and 63 are bonded to each other so that optical axes thereof cross each other, and thus, the laser beam L can be repeatedly separated. Consequently, the laser beam L is separated into four partial beams L₁, L₂, L₃, and L₄.

For example, a first optical axis 62a of the first birefringent medium 62 is inclined at an angle of θ ₂ from −y direction in a clockwise direction on the xy plane, and a second optical axis 63a of the second birefringent medium 63 is inclined from the y axis at an angle of θ ₃ in a counter-clockwise direction on the xy plane. In this case, the ordinary ray of the first birefringent medium 62 is the light polarized perpendicularly to the first optical axis 62a. That is, the ordinary ray of the first birefringent medium 62 is polarized in a direction that is inclined by θ ₂+90° from −y axis in the clockwise direction on the xy plane. The extraordinary ray of the first birefringent medium 62 is polarized in a direction parallel to the first optical axis 62a. The ordinary ray of the second birefringent medium 63 is polarized perpendicularly to the second optical axis 63a, and the extraordinary ray of the second birefringent medium 63 is polarized parallel to the second optical axis 63a.

In FIGS. 5A and 5B, rays denoted as solid lines are ordinary rays, and rays denoted as dotted lines are extraordinary rays. The polarization directions of the partial beams L₁, L₂, L₃, and L₄ are based on a case where the angle θ ₂ is about 45° and the angle θ ₃ is about 90°. That is, among the partial beams L₁, L₂, L₃, and L₄ separated by the second birefringent medium 63, the first and fourth partial beams L₁ and L₄ are extraordinary rays, the polarization directions of which are parallel to the second optical axis 63a, and the second and third partial beams L₂ and L₃ are ordinary rays, the polarization directions of which are perpendicular to the second optical axis 63a.

The first optical axis 62a and the second optical axis 63a may cross each other such that an angle formed between them is within a range from 40° to 50°. In this case, the ordinary ray and the extraordinary ray separated by the first birefringent medium 62 have the polarization direction that is inclined at an angle within a range from 40° to 50° with respect to the second optical axis 63a. In addition, when the ordinary ray and the extraordinary ray are incident on the second birefringent medium 63, the ordinary ray and the extraordinary ray separated by the second birefringent medium 63 have similar light intensities to each other. As described above, when the first optical axis 62a and the second optical axis 63a cross each other within the range of 40°˜50°, the partial beams L₁, L₂, L₃, and L₄ that are separated through the birefringent device 61 have similar light intensities to each other.

The arrangement of the first and second optical axes 62a and 63a is an example, and the present invention is not limited to the above example. The first and second birefringent media 62 and 63 are arranged so that the first optical axis 62a and the second optical axis 63a cross each other and are inclined at an angle to the polarization directions of the incident laser beam L. Even if directions of the first and second optical axes 62a and 63a are changed, the four partial beams L₁, L₂, L₃, and L₄ can be separated.

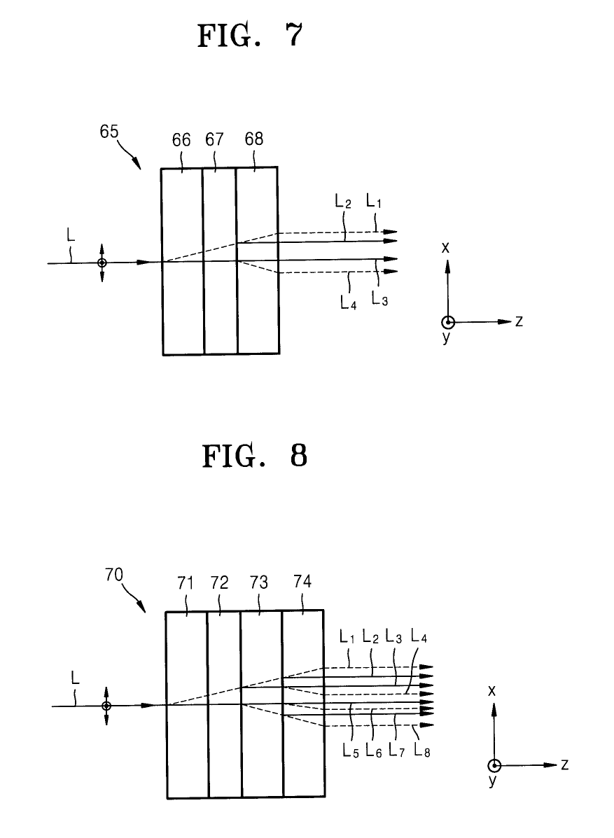

When the birefringent device 61 is used instead of the birefringent device 60 shown in FIG. 3A, four spots overlap with each other with slight displacements on the screen (S of FIG. 1) to form one pixel as shown in FIG. 6. Accordingly, the speckle contrasts generated by the partial beams L₁, L₂, L₃, and L₄ can be equalized, and thus, the speckle can be reduced. In the current embodiment, since four spots form one pixel, the speckle contrast is reduced by 1/\sqrt{4} in average.

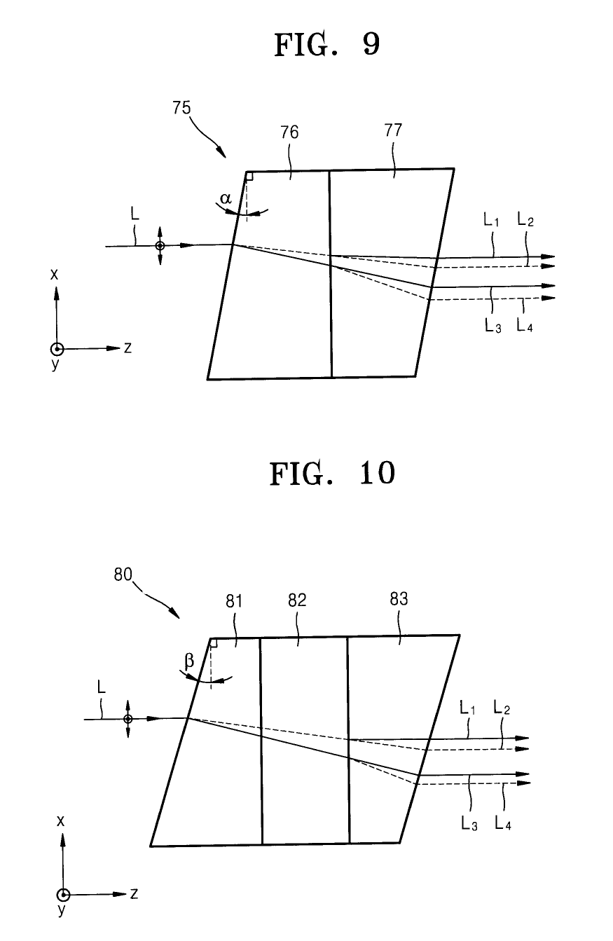

The birefringent device according to another exemplary embodiment of the present invention will be described with reference to FIG. 7.

In the birefringent device 65 according to the current exemplary embodiment including two birefringent media, the birefringent media are not necessarily bonded to each other, but can be separated a predetermined distance from each other in parallel. Moreover, an additional transparent member can be disposed between the birefringent media.

The birefringent device 65 according to the current embodiment includes first and second birefringent media 66 and 68, and a flat type transparent member 67 disposed between the first and second birefringent media 66 and 68. The first and second birefringent media 66 and 68 are substantially the same as those included in the birefringent device 60 shown in FIGS. 3A and 3B, and thus, detailed descriptions thereof will be omitted.

The first and second birefringent media 66 and 68 are disposed so that optical axes thereof are deviated from each other, and thus, the laser beam L can be separated repeatedly. For example, the first and second optical axes of the first and second birefringent media 66 and 68 can be set as the optical axes 62a and 63a of the first and second birefringent media 62 and 63 shown in FIGS. 5A and 5B. In FIG. 7, the rays denoted as solid lines are ordinary rays, and the rays denoted as dotted lines are extraordinary rays of the birefringent media 66 and 68.

The transparent member 67 is an optical device having an incident surface and an exit surface that are parallel to each other, and makes the ordinary ray and the extraordinary ray separated by the first birefringent medium 66 separate farther from each other. The ordinary ray and the extraordinary ray passing through the transparent member 67 are separated by the second birefringent medium 68 into four partial beams L₁, L₂, L₃, and L₄.

According to the birefringent device of the present invention, distances between the partial beams become larger in proportion to the thickness of the birefringent device. The birefringent device is an expensive optical component, and in particular, fabrication costs increase greatly in a case where a thick birefringent device is used to increase the distances between the partial beams. However, when the transparent member 67 is disposed between the birefringent media 66 and 68 like in the current embodiment, the distances between the partial beams can be increased sufficiently enough by the transparent member 67 in order to reduce the speckles even if the thickness of the birefringent media 66 and 68 is small.

When the birefringent device 65 according to the current exemplary embodiment is used instead of the birefringent device 60 shown in FIG. 3A, four spots on the screen S overlap with each other while slightly dislocating with each other to form one pixel, and thus, the speckle contrast generated due to the partial beams L₁, L₂, L₃, and L₄ can be equalized. Since the four spots overlap with each other to form one pixel in the current embodiment, the speckle contrast can be reduced by 1/\sqrt{4} on average.

FIG. 8 illustrates another modified example of the birefringent device according to another exemplary embodiment.

Referring to FIG. 8, a birefringent device 70 according to the current example includes a first birefringent medium 71, a second birefringent medium 73, a third birefringent medium 74, and a flat plate type transparent member 72 disposed between the first and second birefringent media 71 and 73. The first through third birefringent media 71, 73, and 74 are each substantially the same as the birefringent device 60 shown in FIGS. 3A and 3B, and thus, detailed descriptions of each of the first through third birefringent media 71, 73, and 74 will be omitted. In addition, the transparent member 72 is also substantially the same as the transparent member 67 shown in FIG. 7, and thus, detailed description of the transparent member 72 is omitted.

First through third optical axes of the first through third birefringent media 71, 73, and 74 are arranged on the xy plane to deviate from each other. The laser beam L is separated into eight partial beams L₁,L₂, . . . ,L₈ while being separated into the ordinary rays and extraordinary rays repeatedly in the birefringent media 71, 73, and 74.

Here, adjacent optical axes may cross each other within a range of 40° to 50° in order for the eight partial beams L₁,L₂, . . . ,L₈ separated by the birefringent device 70 to have similar light intensities. For example, the first optical axis and the second optical axis cross each other within a range of 40° to 50°, and the second optical axis and the third optical axis cross each other within a range of 40° to 50°. In this case, the ordinary ray and the extraordinary ray separated by the first birefringent medium 71 are polarized at angles ranging from 40° to 50° with respect to the second optical axis. In addition, the ordinary ray and the extraordinary ray separated by the second birefringent medium 73 are polarized at angles ranging from 40° to 50° with respect to the third optical axis. Therefore, the eight partial beams L₁,L₂, . . . ,L₈ finally separated by the third birefringent medium 74 have similar light intensities to each other.

For example, the first optical axis can be parallel to the x axis, the second optical axis can be inclined at an angle of about 40° to 50° from the x axis in the clockwise direction on the xy plane, and the third optical axis of the third birefringent medium 74 can be parallel to the x axis. In this case, the laser beam L that is circularly polarized is incident into the first birefringent medium 71, and then, separated into the ordinary ray having the linearly polarized component in the y direction (that is, the direction perpendicular to the first optical axis) and the extraordinary ray having the linearly polarized component in the x direction (that is, the direction of the first optical axis). The ordinary ray and the extraordinary ray separated by the first birefringent medium 71 are incident into the second birefringent medium 73 while being separated from each other by the transparent member 72. Each of the ordinary ray and the extraordinary ray is separated into the ordinary ray having the polarization component perpendicular to the second optical axis and the extraordinary ray having the polarization component that is in parallel to the second optical axis, and thus, four partial beams are generated. The four partial beams are incident on the third birefringent medium 74, and then, separated into the ordinary rays having the linearly polarized component in the y direction (that is, the direction perpendicular to the third optical axis) and the extraordinary rays having the linearly polarized component in the x direction (that is, the direction in parallel to the third optical axis), and then, eight partial beams L₁,L₂, . . . ,L₈ are generated.

In the current modified example, the transparent member 72 is disposed between the first and second birefringent media 71 and 73, however, it can be disposed between the second and third birefringent media 73 and 74. Like the transparent member 67 shown in FIG. 7, the transparent member 72 makes the partial beams L₁,L₂, . . . ,L₈ separate from each other sufficiently even when the birefringent media 71, 73, and 74 are formed to be thin.

When the birefringent device 70 is used instead of the birefringent device 60 shown in FIG. 3A, eight spots formed on the screen S overlap with each other with slight dislocation between them to form one pixel, and thus, the speckle contrast can be reduced by 1/\sqrt{8} on average. Therefore, the speckle reducing effect is superior to the above examples.

FIG. 9 is a diagram of another modified example of the birefringent device according to the present invention.

Referring to FIG. 9, the birefringent device 75 of the current example includes a first birefringent medium 76 and a second birefringent medium 77 each of wedge-shapes.

An incident surface of the first birefringent medium 76 and an exit surface of the second birefringent medium 77 correspond to inclination surfaces which are inclined with respect to the direction of the incident laser light L. The first and second birefringent media 76 and 77 are formed as wedges so that the inclination surfaces i.e. the incident surface of the first birefringent medium 76 and the exit surface of the second birefringent medium 77 are inclined at the same angle and are parallel to each other. As described above, when the wedge-shaped birefringent media 76 and 77 are used, the laser beam L is incident at an angle to the birefringent device 75, and thus, the ordinary ray is also refracted in the birefringent device 75 unlike the above examples. Here, since the refraction angle is in proportion to the incident angle, the inclination angle α of the inclination surfaces of the birefringent media 76 and 77 can be increased in order to ensure a sufficient distance between the partial beams L₁ and L₂ separated by the birefringent device 75. However, the larger the inclination angle a is, the thicker the birefringent media 76 and 77 is, and thus, the fabrication costs increase. Therefore, the inclination angle α of the inclination surface may range from 0° to 8°. In this case, the incident angle of the laser beam L also ranges from 0° to 8°.

The first and second birefringent media 76 and 77 are bonded to each other while the optical axes thereof cross each other so that the laser beam L can be repeatedly separated. For example, the first and second optical axes of the first and second birefringent media 76 and 77 can be set to be the same as the optical axes 62a and 63a of the first and second birefringent media 62 and 63 shown in FIGS. 5A and 5B.

When the birefringent device 75 of the current example is used instead of the birefringent device 60 shown in FIG. 3A, four spots formed on the screen S overlap with each other with slight dislocation between them to form one pixel, and thus, the speckle contrast can be reduced by 1/\sqrt{4} on average.

FIG. 10 illustrates another modified example of the birefringent device according to the present invention.

Referring to FIG. 10, the birefringent device 80 according to the current example includes wedge-shaped first and second birefringent media 81 and 83, and a transparent member 82 of a flat plate type between the first and second birefringent media 81 and 83. The first and second birefringent media 81 and 83 are substantially the same as the birefringent media 76 and 77 shown in FIG. 9, and the transparent member 82 is substantially the same as the transparent member 67 shown in FIG. 7, and thus, detailed descriptions of those elements are omitted.

A surface of the first birefringent medium 81 on which the laser beam L is incident is an inclination surface, and is inclined with respect to the incident laser beam L. The transparent member 82 is perpendicular to the laser beam L incident into the birefringent device 80. That is, an exit surface of the first birefringent medium 81 and an incident surface of the second birefringent medium 83, which contact the transparent member 82, are perpendicular to the incident laser beam L.

The first and second birefringent media 81 and 83 are bonded to each other while the optical axes thereof cross each other so that the laser beam L can be repeatedly separated. For example, the first and second optical axes of the first and second birefringent media 81 and 83 can be set to be the same as the optical axes 62a and 63a of the first and second birefringent media 62 and 63 shown in FIGS. 5A and 5B.

The laser beam L is incident into the birefringent device 80 while being inclined with reference to the birefringent device 80. The incident angle of the laser beam L is the same as an inclination angle β of the inclination surfaces of the first and second birefringent media 81 and 83. The laser beam L is separated into the ordinary ray and the extraordinary ray in the first birefringent medium 81, and a distance between the partial beams becomes larger in the transparent member 82, and then are separated into four partial beams L₁, L₂, L₃, and L₄ in the second birefringent medium 83.

The current example is substantially the same as the example shown in FIG. 9 except for that the transparent member 82 is disposed between the birefringent media 81 and 83 in the current example. According to the current example, the distance between the partial beams can be increased sufficiently enough to reduce the speckle in the transparent member 82 even when the birefringent media 81 and 83 are thin.

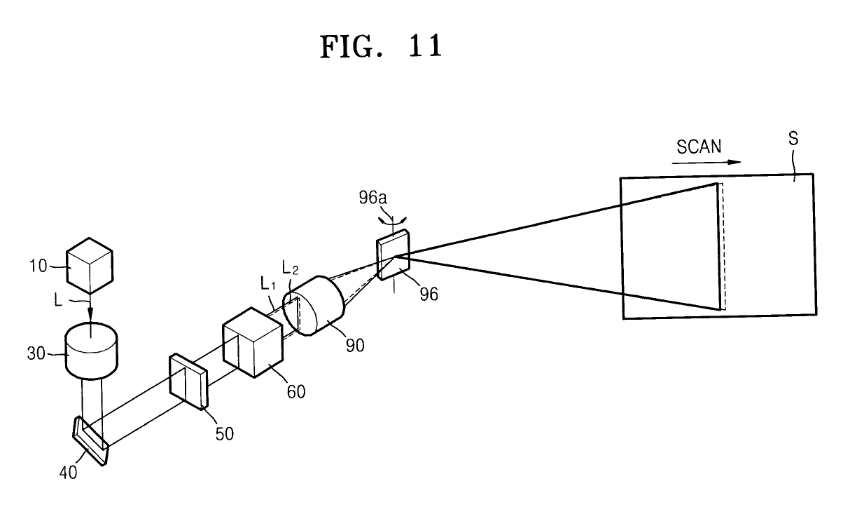

FIG. 11 is a schematic view of a laser display apparatus according to another exemplary embodiment of the present invention.

Referring to FIG. 11, the laser display apparatus according to the current embodiment includes a laser illuminating system 10 emitting laser beam L, a beam shaping element 30 shaping the laser beam L emitted from the laser illuminating system 10 into a beam having a linear cross section, a line panel 40 modulating the laser beam L emitted from the beam shaping element 30 according to image signals, a speckle reducing unit separating the laser beam L modulated by the line panel 40 into two partial beams L₁ and L₂, a one-axis driving micro scanner 96 scanning the separated partial beams L₁ and L₂, and a screen S, on which the images are formed. Here, the speckle reducing unit makes two line-shaped spots formed by the partial beams L₁ and L₂ on the screen S overlap with each other with a slight displacement between them and form one pixel line.

The laser illuminating system 10 is substantially the same as the laser illuminating system shown in FIG. 1, and detailed descriptions of the system 10 are omitted. However, since the laser display apparatus includes the line panel 40 as a light modulator, the laser illuminating system 10 does not need to modulate the output of the laser beam L.

The beam shaping element 30 shapes the beam emitted from the laser illuminating system 10 into a linear beam having a predetermined width. A diffractive optical element (DOE) can be used as the beam shaping element 30.

The line panel 40 is a line type light modulator including a one-dimensional light modulating unit, for example, a grating light valve (GLV), a Samsung optical modulator (SOM), or a grating electromechanical system (GEMS). For example, the GLV adjusts the direction of the light using reflecting and diffracting effects of the light, and includes a ribbon type mirror array in a line. The mirror array includes fixed mirrors and moving mirrors that are alternately arranged. Here, the mirror array includes at least one fixed mirror and at least one moving mirror in each pixel unit. The moving mirrors are moved backward as much as λ/4 from the fixed mirrors, and thus, the reflection direction of the light can be changed by the diffraction. When the fixed mirror and the moving mirror are located on the same plane in each pixel unit, the incident light is totally reflected and a bright pixel is displayed on the screen S. When the moving mirror is driven and located on the different plane from the fixed mirror, most of the reflected light is diffracted, for example, in ±1th order, and proceeds in different direction from the incident light. Thus, the reflected light does not reach the screen S, and accordingly, a dark pixel is displayed on the screen S.

The speckle reducing unit separates the laser beam L modulated by the line panel 40 into at least two partial beams L₁ and L₂, and includes a quarter wave plate 50 and a birefringent device 60. The speckle reducing unit is substantially the same as that shown in FIGS. 1 through 3B, and thus, detailed descriptions for the speckle reducing unit are omitted. In particular, the modified examples shown in FIGS. 5A through 10 can be adopted as the birefringent device 60 according to the current embodiment.

Since the laser beam L incident into the birefringent device 60 has a linear cross-section, the partial beams L₁ and L₂ separated by the birefringent device 60 also have linear cross sections.

The one-axis driving micro scanner 96 scans the partial beams L₁ and L₂ separated by the speckle reducing unit in a direction perpendicular to the length direction of the line panel 40, that is, in a horizontal scanning direction. The one-axis driving micro scanner 96 is an example of the one-dimensional light scanner, and a galvano mirror can be used as the one-axis driving micro scanner which rotates about the axis 96a.

The laser display apparatus according to the current embodiment may further include a project lens unit 90 for expanding and projecting the linear beam modulated by the line panel 40 onto the screen S. In order to reduce the size of the one-axis driving micro scanner 96 or to minimize additional optical elements, the one-axis driving micro scanner 96 may be located on a focal point of the project lens unit 90.

In the current embodiment, the speckle reducing unit is disposed between the line panel 40 and the project lens unit 90, however, the location of the speckle reducing unit is not limited thereto. The speckle reducing unit can be disposed between the beam shaping element 30 and the line panel 40, or can be disposed in the projection lens unit 90. In these modified examples, the laser beam L is also separated into the partial beams L₁ and L₂ by the speckle reducing unit, and functions of the optical elements are the same, and thus, detailed descriptions of those are omitted.

In the laser display apparatus according to the current embodiment, the laser beam L emitted from the laser illuminating system 10 is shaped into the linear beam having a predetermined width, and then, is incident on the line panel 40. The linear laser beam having image information modulated by the line panel 40 according to the image signal is separated into a plurality of partial beams L₁ and L₂ while passing through the speckle reducing unit. The partial beams L₁ and L₂ are linear beams having the image information of the same line. The partial beams L₁ and L₂ separated by the speckle reducing unit are focused by the project lens unit 90, and then, are scanned onto the screen S by the one-axis driving micro scanner 96 located on the focal point of the project lens unit 90 in the direction perpendicular to the length direction of the line panel 40, that is, in the horizontal scanning direction.

The laser display apparatus having the above structure forms a two-dimensional image on the screen S by combining the line panel 40 and the one-axis driving micro scanner 96. Here, the plurality of linear beams having the same image information in the length direction of the line panel 40 overlap with each other with a slight dislocation between them, and thus, one pixel line is formed. That is, each of the pixels forming the pixel line is formed by overlapping the plurality of spots with a slight displacement between them, and thus, the speckles are overlapped in each pixel by the plurality of partial beams L₁ and L₂, the speckle contrast can be equalized and the entire speckle pattern can be reduced.

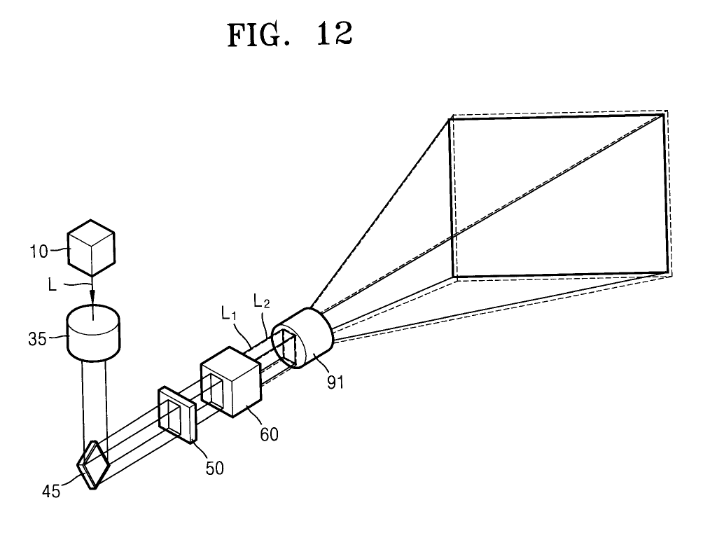

FIG. 12 is a schematic view of a laser display apparatus according to another exemplary embodiment of the present invention. Unlike the laser display apparatus shown in FIG. 11, the laser display apparatus of the current exemplary embodiment includes a flat panel as a light modulator.

Referring to FIG. 12, the laser display apparatus includes a laser illuminating system 10 emitting a laser beam L, a beam shaping element 35 shaping the laser beam L emitted from the laser illuminating system 10 into a predetermined shape, a flat panel 45 modulating the laser beam L shaped by the beam shaping element 35 according to image signals, a speckle reducing unit separating the laser beam L modulated by the flat panel 45 into two partial beams L₁ and L₂, projection optics 91 expanding and projecting the partial beams L₁ and L₂, and a screen S on which the image is formed. Here, the speckle reducing unit makes two two-dimensional images formed on the screen S by the partial beams L₁ and L₂ overlap with each other with a slight displacement between them to form one two-dimensional image.

The laser illuminating system 10 and the speckle reducing unit are substantially the same as those of the above embodiment, and detailed descriptions of those are omitted.

The flat panel 45 may be one of a transmissive liquid crystal display (LCD), a liquid crystal on silicon (LCoS), a deformable micro device (DMD), and a grating light valve (GLV). The flat panel 45 is formed as a square having an aspect ratio of 4:3 or 16:9. The laser beam emitted from the laser illuminating system 10 has a circular cross section, and the flat panel 45 has a square shape. Therefore, the laser beam emitted from the laser illuminating system 10 may be shaped into the shape of the flat panel 45 in order to improve the optical efficiency. Thus, the beam shaping element 35 shapes the laser beam emitted from the laser illuminating system 10 into a beam having a square cross section having a predetermined width suitable for the shape of the flat panel 45.

The speckle reducing unit separates the laser beam L modulated by the flat panel 45 into at least two partial beams L₁ and L₂, and includes a quarter wave plate 50 and a birefringent device 60. The speckle reducing unit is substantially the same as that shown in FIGS. 1 through 3B, and thus, detailed descriptions of the speckle reducing unit are omitted. In particular, the modified examples shown in FIGS. 5A through 10 can be adopted as the birefringent device 60 according to the current embodiment.

Since the laser beam incident into the birefringent device 60 has a square cross section, the partial beams L₁ and L₂ separated by the birefringent device 60 also have square cross sections.

The partial beams L₁ and L₂ are incident into the screen S through the projection optics 91.

In the current exemplary embodiment, the speckle reducing unit is disposed between the flat panel 45 and the projection optics 91, however, the location of the speckle reducing unit is not limited thereto. The speckle reducing unit can be disposed between the beam shaping element 35 and the flat panel 45, or can be disposed in the projection optics 91. In this modified example, the speckle reducing unit also separates the laser beam L into a plurality of partial beams L₁ and L₂, functions of the optical elements are the same, and detailed descriptions of those are omitted.

In the laser display apparatus according to the current exemplary embodiment, the laser beam L emitted from the laser illuminating system 10 is shaped into the laser beam having the square cross section, and incident into the flat panel 45. The laser beam having the square cross section and including two-dimensional image information modulated by the flat panel 45 according to the image signal is separated into the plurality of partial beams L₁ and L₂ while passing through the speckle reducing unit. The separated partial beams L₁ and L₂ have the same two-dimensional image information. The partial beams L₁ and L₂ separated by the speckle reducing unit are diverged and projected onto the screen S by the projection optics 91. Here, each of the pixels forming the two-dimensional image is formed by overlapping the spots formed by the partial beams L₁ and L₂ with a slight displacement. Accordingly, the speckles generated by the plurality of partial beams L₁ and L₂ are overlapped, and thus, the speckle contrast can be equalized and the entire speckle pattern can be reduced.

In the above description, the laser display apparatus includes the screen S, however, the screen S is not an essential element of the laser display apparatus. For example, the laser display apparatus according to the present invention can project on an external screen such as a projector.

As described above, the laser display apparatus according to the present invention overlaps a plurality of partial beams in order to equalize the speckle contrast, and thus, the speckle pattern can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A laser display apparatus comprising:
a laser illuminating system emitting a laser beam; and
a speckle reducing unit including a birefringent device that separates the laser beam emitted from the laser illuminating system into a plurality of partial beams;
wherein the plurality of partial beams form a plurality of spots on a screen that overlap with each other with a slight displacement therebetween so that a speckle pattern is reduced.

2. The laser display apparatus of claim 1, wherein the speckle reducing unit further comprises:
a polarization converter disposed between the laser illuminating system and the birefringent device for changing the incident laser beam into a laser beam including a first polarization component and a second polarization component which are orthogonal to each other.

3. The laser display apparatus of claim 2, wherein the polarization converter is a quarter wave plate.

4. The laser display apparatus of claim 1, wherein the birefringent device includes at least one flat plate type birefringent medium.

5. The laser display apparatus of claim 4, wherein an optical axis of the birefringent device is inclined to a polarization direction of the incident laser beam.

6. The laser display apparatus of claim 1, wherein the birefringent device includes at least two birefringent media, and an incident surface and an exit surface of the birefringent device are parallel to each other.

7. The laser display apparatus of claim 6, wherein an optical axis of the birefringent medium having the incident surface of the birefringent device is inclined to the polarization direction of the incident laser beam.

8. The laser display apparatus of claim 7, wherein the birefringent media are bonded to each other so that optical axes cross each other.

9. The laser display apparatus of claim 7, wherein the birefringent media are wedge-shaped, and the incident surface and the exit surface of the birefringent device are disposed parallel to each other.

10. The laser display apparatus of claim 9, wherein an inclination surface of the birefringent medium is inclined so that an incident angle of the laser beam is in the range of 0° to 8°.

11. The laser display apparatus of claim 6, wherein a flat plate type transparent member is disposed between the birefringent media.

12. The laser display apparatus of claim 1, further comprising:
an optical scanning unit deflecting the laser beam and scanning the laser beam onto the screen,
wherein the speckle reducing unit is disposed between the laser illuminating system and the optical scanning unit.

13. The laser display apparatus of claim 12, wherein the optical scanning unit is a two-dimensional optical scanner.

14. The laser display apparatus of claim 12, wherein the laser illuminating system emits the laser beam that is modulated according to an image signal.

15. The laser display apparatus of claim 1, further comprising:
a beam shaping element shaping the beam emitted from the laser illuminating system into a beam having a linear cross section;
a line panel modulating the laser beam output from the beam shaping element according to an image signal; and
a one-dimensional optical scanner scanning the laser beam in a direction perpendicular to a length direction of the line panel in synchronization with the image signal.

16. The laser display apparatus of claim 15, wherein the speckle reducing unit is disposed between the line panel and the one-dimensional optical scanner.

17. The laser display apparatus of claim 15, wherein the speckle reducing unit is disposed between the beam shaping element and the line panel.

18. The laser display apparatus of claim 15, further comprising:
a project lens disposed between the line panel and the one-dimensional optical scanner.

19. The laser display apparatus of claim 18, wherein the speckle reducing unit is disposed in the project lens.

20. The laser display apparatus of claim 1, further comprising:
a flat panel modulating the laser beam emitted from the laser illuminating system according to an image signal to form an image; and
a projection optics unit expanding and projecting the image formed by the flat panel onto the screen.

21. The laser display apparatus of claim 20, further comprising:
a beam shaping element shaping the laser beam emitted from the laser illuminating system into a beam having a shape corresponding to the shape of the flat panel.

22. The laser display apparatus of claim 20, wherein the speckle reducing unit is disposed between the laser illuminating system and the flat panel.

23. The laser display apparatus of claim 20, wherein the speckle reducing unit is disposed between the flat panel and the projection optics unit.

24. The laser display apparatus of claim 20, wherein the speckle reducing unit is disposed in the projection optics unit.

25. The laser display apparatus of claim 20, wherein the flat panel is one of a transmissive liquid crystal display (LCD), a liquid crystal on silicon (LCoS), a deformable micro device (DMD), and a grating light valve (GLV).
